(19) United States
(12) Patent Application Publication
(10) Pub. No.: US 2007/0011284 A1
(43) Pub. Date: Jan. 11, 2007

(54) Dynamic distributed method for local protection of a label switching path

(75) Inventors: Jean-Louis Le Roux, Trebeurden (FR); Geraldine Calvignac, Pleumeur Bodou (FR); Renaud Moignard, Trebeurden (FR)

Correspondence Address: LOWE HAUPTMAN BERNER, LLP, 1700 DIAGONAL ROAD, SUITE 300, ALEXANDRIA, VA, 22314, US

(73) Assignee: FRANCE TELECOM SA, Paris (FR)

(21) Appl. No.: 10/505,484

(22) PCT Filed: Feb. 17, 2003
(86) PCT No.: PCT/FR03/00513

§ 371 Date: Nov. 21, 2005

(30) Foreign Application Priority Data
Feb. 21, 2002 (FR) 02 02437

(51) Int. Cl. G06F 15/173

(52) U.S. Cl. 709/223

(57) ABSTRACT

The invention concerns a method of protecting a label switching path in an MPLS network comprising a plurality of nodes connected by IP links, the said path commencing with an ingress node and ending in an egress node of the said network, passing through a given series of nodes and links in the said network, referred to as elements of the said path. When the said ingress node requires the protection of an element of the path, in a first phase a node on the said path, referred to as the PLR point, upstream of the said element to be protected, determines a back-up path, referred to as the bypass tunnel, joining the path upstream of the said element to be protected at a node, referred to as the PM point, and, in a second phase, network resources are reserved on each of the links of the bypass tunnel in order to back up the said path in the event of failure of the said element.

The present invention concerns a method of protecting label switching paths in an MPLS (MultiProtocol Label Switching) network. More particularly the present invention relates to a method of local protection of such paths with resource sharing.

The MPLS standard, published under the auspices of the IETF (Internet Engineering Task Force) is a technique based on label switching for creating a connection oriented network from a network of the datagram type such as the IP network. Detailed documentation of the MPLS protocol will be found on the site www.ietf.org.

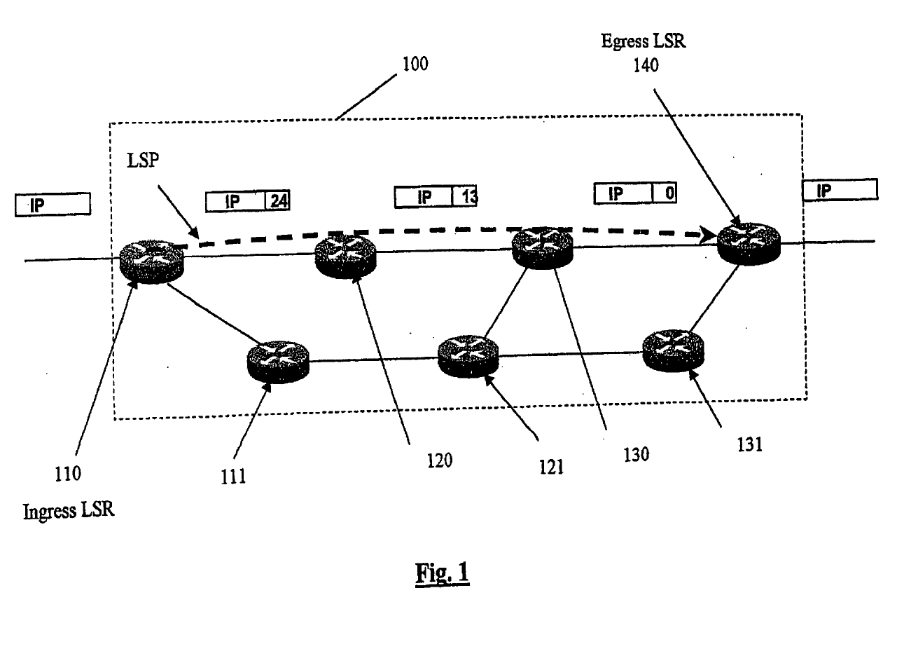

FIG. 1 shows schematically an MPLS network 100 comprising a plurality of routers called LSRs (Label Switching Routers) such as 110, 111, 120, 121, 130, 131, 140, connected together by IP links. When an IP packet arrives on a peripheral ingress node 110, called Ingress LSR, the latter allocates a label to it (here 24) according to its IP header and concatenates it with the said packet. The router which receives the label packet replaces the (incoming) label with an outgoing label according to its routing table (in the example in question 24 is replaced by 13) and the process is repeated from node to node as far as the egress router 140 (also called Egress LSR), which deletes the label before transmitting the packet. Alternatively, the label deletion can already be carried out by the penultimate router since the egress router does not use the incoming label.

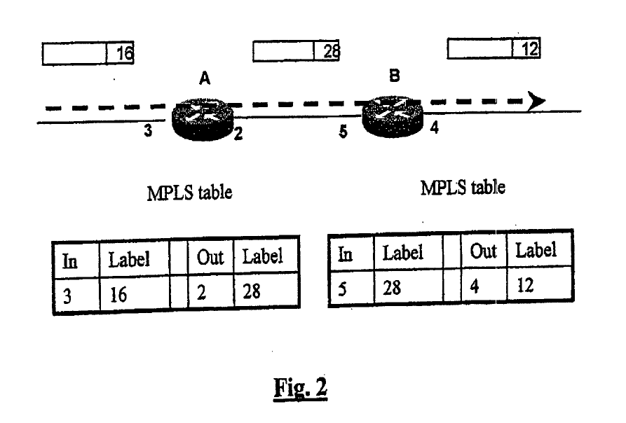

As indicated in FIG. 2, an LSR router uses the label of the incoming packet (incoming label) in order to determine the exit port and the label of the outgoing packet (outgoing label). Thus for example the router A replaces the labels of the IP packets arriving on the port 3 and of value 16 with labels of value 28 and then sends the packets thus relabelled to the port 2.

The path travelled by a packet through the network of the ingress router (Ingress LSR) as far as the egress router (Egress LSR) is called the Label Switched Path or LSP. The LSR routers over which the path travels, distinct from the ingress and egress routers, are called the transit routers. Moreover, all the IP packets which are transmitted along one and the same path are called the equivalence class or FEC (Forward Equivalence Class).

One of the advantages of the MPLS protocol is to be able to force the IP packets to follow a preestablished LSP path which is not in general the optimum IP path in terms of number of bonds or path metric. The technique of determining the path or paths to be taken is called traffic engineering or MPLS-TE (standing for MPLS Traffic Engineering). The determination of the path takes into account constraints on the available resources (constraint based routing), in particular in terms of bandwidth on the various links in the network. Unlike the conventional IP routing operating according to a hop by hop mode (hop-by-hop routing), the determination of an LSP path is effected according to a so-called explicit mode (explicitly routed LSP or ER-LSP) in which some or all the nodes in the path from the ingress router to the egress router are determined. When all the nodes on the path are fixed, explicit routing is spoken of in the strict sense of the term. An LSP path determined according to an explicit mode is also called an MPLS tunnel.

One or more of the paths can be determined in a centralised or distributed manner.

According to the distributed method, also referred to as constraint based routing, each router is given information on the topology of the network and the constraints affecting the various links in the network. To do this, each router determines and transmits to its neighbours a message indicating its immediate links and the constraints (or attributes) which are associated therewith. These messages are then propagated from node to node by extended IDP messages according to a flooding mechanism until all the routers are informed. Thus each router has by rights a database (referred to as TED, standing for Traffic Engineering Database) giving it the topology of the network and its constraints.

The label switching path is then determined by the ingress router (Ingress LSR) also taking account of other constraints fixed by the network operator (for example avoiding such and such a node or avoiding links of such and such a type). The Ingress router then determines, for example by means of Dijkstra's algorithm, the shortest path satisfying all the constraints (Constraint Shortest Path First or CSPF), those affecting the links and those fixed by the operator. The shortest path is then signalled to the nodes on the LSP path by means of the signalling protocols known by the abbreviations RSVP-TE (Resource reSerVation Protocol for Traffic Engineering) or CR-LDP (Constrained Route Label Distribution Protocol). A description of the RSVP-TE protocol will be found in the document by D. Adwuche et al. entitled “RSVP-TE: Extensions to RSVP for LSP tunnels” available on the aforementioned site of the IETF.

These MPLS signalling protocols allow the distribution of the labels along the path and the reservation of the resources.

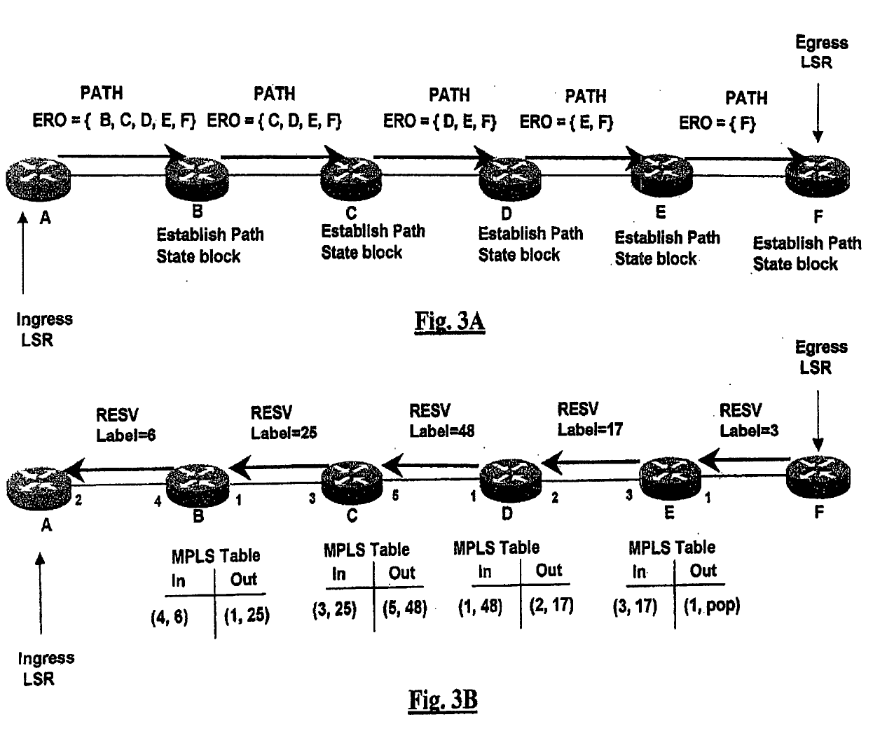

For example, if the RSVP-TE signalling protocol is used, the ingress router A transmits, as indicated in FIG. 3A, a message “Path” in an IP packet to the egress router F. This message specifies the list of the nodes through which the LSP path must pass. At each node the message “Path” establishes the path and makes a state reservation. When the message “Path” reaches the egress router, an acknowledgement message “Resv” is sent by the same path to the ingress router, as indicated in FIG. 3B. At each node, the MPLS routing table is updated and the resource reservation is carried out. For example, if the resource is a bandwidth and it is wished to reserve 10 units (MHz) for the path, the bandwidths respectively allocated to each link are decremented by the reserve value (10) during the retropropagation of the acknowledgement/reservation message. It should be noted that the resource in question (for example the bandwidth) is a logic resource on the IP link rather than a physical resource. When the acknowledgement message is received by the ingress router, the tunnel is established.

As indicated above, the LSP paths can be determined in a centralised manner. In this case, a server has knowledge of the topology of the network and takes account of the constraints on the links and the constraints fixed by the network operator in order to determine tunnels between the ingress routers and the egress routers. The ingress routers are then advised by the server of the tunnel or tunnels for which they are the ingress node. The tunnels are then established as indicated in FIGS. 3A and 3B. The centralised determination method has the advantage of great stability and predictability since a single device effects the prior calculation of all the tunnels. On the other hand it has the drawback of not easily adapting to rapid variations in the topology of the network, for example in the event of rupture of a physical link, eliminating the IP links which it supports.

Whether they have been calculated in a centralised or distributed manner, the tunnels are liable to be destroyed in the event of cutting of an underlying physical link. It is then necessary to provide back-up mechanisms for establishing a new tunnel between the same ingress router and the same egress router. It is possible to distinguish the restoration mechanisms establishing a back-up tunnel after the cutting off and the protection mechanisms pre-establishing a back-up tunnel in provision for a possible cutoff.

The advantage of the protection mechanisms is to allow a very rapid resumption of traffic, a back-up tunnel being already available. On the other hand, they have the drawback of using significant resources of the network. More precisely, the protection mechanisms known from the prior art are divided into local protection methods and end to end protection methods. In the first, local back-up tunnels are pre-established in provision for the failure of an element (node, link) of the initial tunnel. When the failure occurs, the traffic is diverted into the local tunnel in order to bypass the faulty element. In the end to end protection methods, a back-up tunnel is established from the ingress router to the egress router. Contrary to the restoration methods (where the back-up tunnels are created on request), the protection methods (where the back-up tunnels are created in advance) are greedy in terms of network resources.

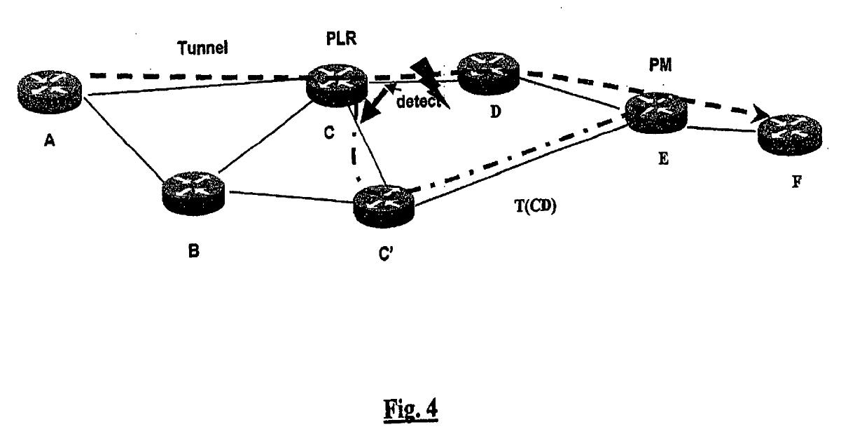

From the prior art, in particular from the document entitled “Fast-Reroute Techniques in RSVP-TE” by P. Pan et al., available on the above-mentioned IETF site under the reference “draft-pan-rsvp-fastreroute-00.txt”, various local protection methods (or FRR for Fast ReRoute) for a tunnel are known. The general principle of this local protection is set out in FIG. 4. For an element (link, node) of the tunnel to be protected, a local back-up tunnel is provided in order to bypass it. For example, in order to bypass the link CD, a back-up tunnel T(CD) is provided, having C, C′, E as its path. The upstream router which detects and repairs the fault in the path by orienting the packets onto the back-up tunnel is called the PLR point (standing for “Point of Local Repair”). The router downstream of the fault where the back-up tunnel rejoins the initial tunnel is called the PM point (standing for “Point of Merging”). In the present case, the router C detects the fault in the link CD (represented by a flash of lightning) through the absence of RSVP messages “Hello” transmitted at regular intervals over the link CD by the router D or by an alert on the underlying physical layer. The router C then reroutes the traffic from the initial path onto the bypass tunnel CC′E. The junction between the initial path and the bypass tunnel is produced at E.

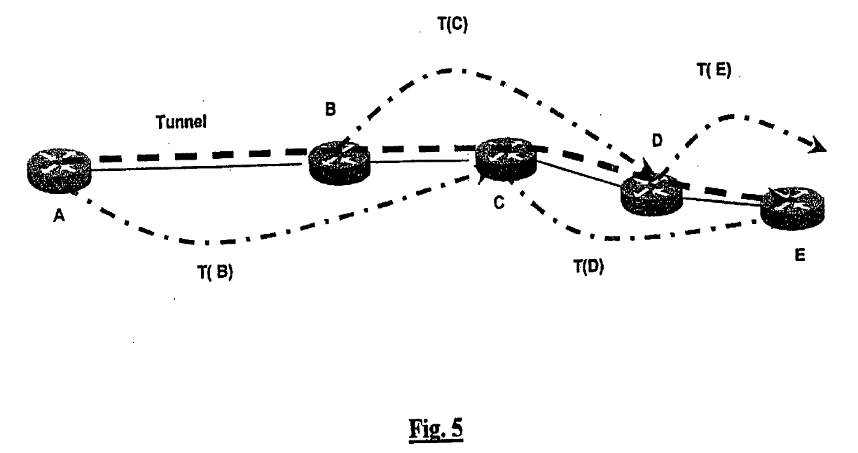

A first local LSP path protection method, referred to as “one-to-one”, consists of creating, for each element of the path to be protected, a local back-up tunnel, also referred to as a “detour”. FIG. 5 illustrates a local protection method of the “one-to-one” type. Each element K of the path is protected by a detour denoted T(K). It should be noted that a detour T(N) for a node N also protects the link upstream and the link downstream of the node. If the tunnel comprises n nodes, there may therefore be up to (n-1) detours. If several tunnels are to be protected in the MPLS network, a series of detours will have to be provided for each of them. This protection method is therefore not extensible (scalable).

It is important to note that the detours are created dynamically when the path is established. In addition, the detours are created in a distributed manner by the transit routers of the path, at the initiative of the ingress router. Thus, in the case of a change in topology of the network or modification of the resource constraints, the detours will not necessarily be the same for the same path. The procedure of creating the detours requires modification of the RSVP signalling, as described in the above-mentioned document.

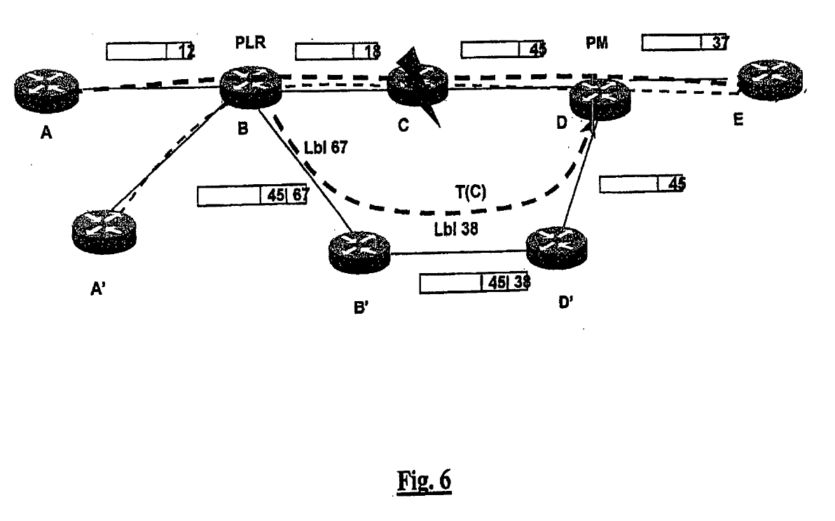

According to a second local LSP path protection method, referred to as “many-to-one”, a back-up tunnel, referred to as a bypass tunnel, is provided for the operator for protecting one or more elements (node, link) of the MPLS network. A bypass tunnel can serve to back up a plurality of paths following the said element or elements. By way of example, FIG. 6 illustrates two paths to be protected T₁=ABCDE and T₂-A′BCDE sharing the path BCDE. In the present case, the operator has made provision for protecting the node C by configuring the bypass tunnel having the path BB′D′D. This bypass tunnel makes it possible to back up the two paths T₁ and T₂ in the event of failure of the node C (or one of the links BC, CD). In general terms, a bypass tunnel makes it possible to back up a plurality of paths which intersect it upstream of the fault at a common PLR point and downstream of the fault at a common point PM. The bypass tunnel takes advantage of the possibility of stacking the labels (label stacking) by allocating to them various hierarchy levels for rerouting the packets in a transparent manner. More precisely, as indicated in FIG. 6, the routers along the path T₁ switch the labels 12, 18, 45 and 37. When a failure of the node C occurs, the router B stacks a label (here 67) locally representing the bypass tunnel. At the penultimate node of the bypass tunnel (here D′), the label locally representing the bypass tunnel (here 38) is unstacked so that the point PM receives a label identical to that (45) of a packet which has not been rerouted.

Hereinafter two types of bypass tunnel will be distinguished: those which protect a link, also referred to as NHOP bypass (standing for next-hop bypass) or those which protect a node or NNHOP bypass (standing for next-next-hop bypass).

It is important to note that the bypass tunnels are determined in advance, in a statistical and/or centralised manner by a specialised server, without taking account a priori of the resource requirements of the future LSP paths to be established and the variations in network resources. In particular, the bandwidth of the bypass tunnel may not be sufficient to transport the required band of the path to be protected. Thus, although a bypass tunnel is present, it will not make it possible to effectively back up the path to be protected.

The problem at the basis of the invention is to propose a method of protecting LSP paths which remedies the aforementioned drawbacks, in particular which is extensible and which is adapted to take account of rapid variations in network resources whilst guaranteeing efficacy of protection.

A subsidiary problem at the basis of an embodiment of the invention is to propose a method of protecting LSP tunnels which consumes fewer resources than the known protection methods of the prior art.

The problem is resolved by the object of the invention, defined as a method of protecting a label switching path in an MPLS network comprising a plurality of nodes connected by IP links, the said path commencing at an ingress node and ending at an egress node in the said network, passing through a given series of nodes and links in said network, referred to as elements of the said path. When the said ingress node requires the protection of an element of the path, in a first phase, a node on the said path, referred to as the PLR point, upstream of the said element to be protected, determines a back-up path, referred to as a bypass tunnel, rejoining the path downstream of the said element to be protected at a node, referred to as the PM point, and, in a second phase, network resources are reserved on each of the links of the bypass tunnel for backing up the said path in the event of failure of the said element.

The said resources on a bypass tunnel link comprise for example a reserved bandwidth relating to this link.

Advantageously, for each physical element of the said network, a group of links of the said network affected by the fault in the said physical element is determined and, vice-versa, for each link in the said network, the list, referred to as the SRLG list, of the said groups to which it belongs is determined.

Advantageously, the PLR point seeks, in a first step of the first phase, the bypass tunnels existing in the network able to protect the said element.

If the element to be protected is a link, the PLR point determines whether an existing bypass tunnel is able to protect the said link by checking that the said tunnel does not comprise the said link and that the SRLG list associated with each link in the said existing tunnel and the SRLG list associated with the link to be protected have an empty intersection.

If the element to be protected is a node, the PLR point determines whether an existing bypass tunnel is able to protect the node by checking that the said tunnel does not comprise the said node and that the SRLG list associated with each link of the said existing tunnel and the SRLG list associated with the link joining the PLR point and the said node have an empty intersection.

Next, for each existing bypass tunnel able to protect the said element, referred to as the candidate tunnel, the PLR point simulates, for each link in the candidate tunnel, an increase in the bandwidth reserved on this link by the value of the bandwidth of the switched label path and checks whether the value of the bandwidth thus obtained is less than a maximum bandwidth which can be reserved on this link.

Alternatively, for each existing bypass tunnel able to protect the said element, referred to as the candidate tunnel, the PLR point simulates a protection of the said element by the said candidate tunnel and determines, for each link in the said candidate tunnel, the greatest bandwidth to be reserved on this link in order to support the bypass tunnels passing through this link, including the candidate tunnel, in the case of failure of any physical element in the network, and it is checked whether the said greatest bandwidth is less than a maximum bandwidth which can be reserved on this link.

If there exists no candidate tunnel or if the check is negative for at least one link in each candidate tunnel, the PLR point determines a new bypass tunnel.

Advantageously, in the said second phase, the PLR point transmits a first message propagating from node to node on the bypass tunnel towards the point PM and a second message is returned along the bypass tunnel to the PLR point, and, on passing from the first to the second message, it is checked for each link in the bypass tunnel that it is able to protect the said clement and that the said resources are actually available on this link, and in the affirmative the said resources are reserved.

The object of the invention is also defined by existing new protocol messages.

The characteristics of the invention mentioned above, as well as others, will emerge more clearly from a reading of the following description of embodiments, the said description being given in relation to the accompanying drawings, amongst which:

FIG. 1 illustrates an MPLS network known from the prior art;

FIG. 2 illustrates schematically the creation of a switched label path;

FIG. 3A illustrates schematically a first phase of the procedure of establishing an LSP path;

FIG. 3B illustrates schematically a second phase of the procedure of establishing an LSP path;

FIG. 4 illustrates schematically the principle of local repair of an LSP path;

FIG. 5 illustrates schematically a distributed method of local protection of an LSP path, known from the prior art;

FIG. 6 illustrates schematically a centralised method for local protection of an LSP path, known from the prior art;

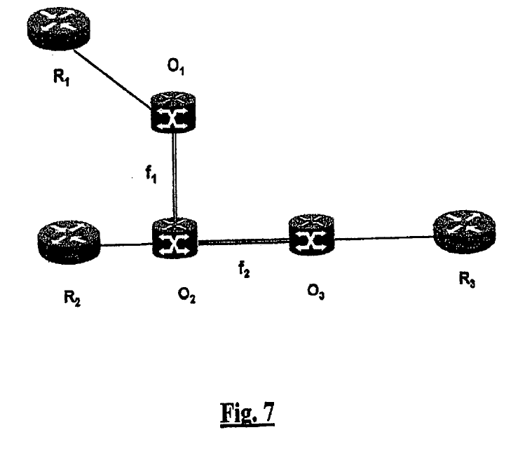

FIG. 7 illustrates the concept of shared risk entities;

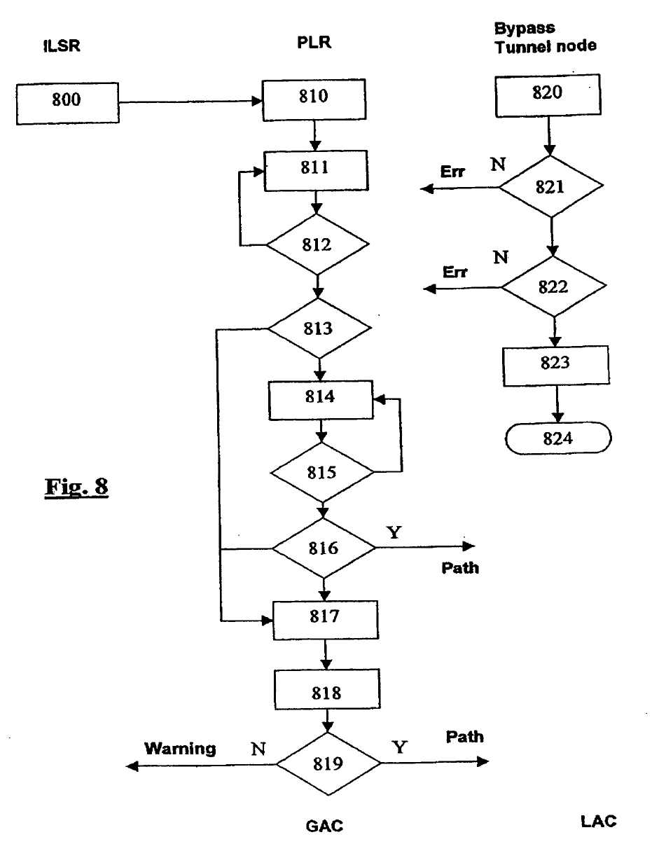

FIG. 8 illustrates schematically a distributed method for the local protection of LSP paths according to the present invention.

The idea at the basis of the invention is to provide a method for the dynamic distributed generation of bypass tunnels. In general terms, when an LSP path is to be the subject of local protection, the ingress router advises the PLR point (Point of Local Repair) upstream of the element to be protected. This point determines first of all whether there exists a bypass tunnel which passes through it and which is able to protect the said element. Where applicable, it checks whether the bypass tunnel has sufficient resources, in particular in terms of bandwidth, to support the traffic of the path to be protected and, in the negative, it checks that it can increase them. If no bypass tunnel can be adopted or if it is not possible to increase the resources of the tunnel adopted, the PLR point then attempts to determine a new bypass tunnel for protecting the element in question. Advantageously, it uses to do this existing tunnel elements, sharing the resources. Finally, if no bypass tunnel can be established, the PLR point advises the ingress router of this. When the LSP path is eliminated, the ingress router can transmit an elimination method to the PLR point, which then releases the resources which have been reserved for protecting the element in question.

The resources which can be reserved or released respectively when a bypass tunnel is created or eliminated are in particular the bandwidth. Bandwidth means here a logic bandwidth dedicated to protection, without direct relationship with the physical bandwidth. More precisely, a physical bandwidth associated with an element of the network (for example a link) comprises a logic bandwidth dedicated to normal traffic and a logic bandwidth dedicated to back-up traffic. The latter, also referred to as protection bandwidth, can be used, partially or entirely, by the bypass tunnels. The value of the protection bandwidth on a link L in the network will be denoted RBP(L) and the value of the bandwidth actually used or reserved by the bypass tunnels using this link will be denoted rBP(L).

It will be assumed first of all that each node (LSR router) in the network not only has knowledge of the topology of the network but also of the existing bypass tunnels, their characteristics (list of nodes and links, bandwidth to be protected) and, for each bypass tunnel, the element in the network which it protects. This information can be broadcast in the network as that relating to the topology of the network by means of messages whose content will be explained later. Each PLR which has created a bypass tunnel sends a message (announcement) to its neighbours identifying the said tunnel, its characteristics and the element which it protects. This message is passed on from node to node throughout the network. When the bypass tunnel is eliminated, an elimination message is also transmitted and broadcast throughout the network.

Hereinafter the term shared risk entity or SRLG (standing for Shared Risk Link Group) associated with a link will be given to all the links in the network sharing the same physical resource with the aforementioned link and all affected by the failure of this physical resource. This concept of shared risk entity was introduced by K. Kompella et al. in a document entitled “Routing extensions in support of generalized MPLS” available on the IETF site under the reference “draft-ietf-ccamp-gmpls routing-01.txt”. A link may belong to several SRLGs or belong to none of them. The SRLG list of a link is defined as the list of SRLGs in which this link appears. Two links have an SRLG diversity if their SRLG lists have an empty intersection. In particular two links belonging to no SRLG have an SRLG diversity.

The concept of SRLG lists will be understood better by means of the example in FIG. 7. It is assumed that three routers R₁, R₂, R₃ are interconnected by means of optical stirrers (OXC) O₁, O₂, O₃. These optical stirrers are interconnected by means of optical fibres f₁, f₂ with WDM multiplexing. Let S₁, S₂ be the SRLGs associated respectively with the fibres f₁ and f₂. The link R₁R₂ uses solely the light path O₁-O₂ and its SRLG list is {S₁}. The link R₁R₃ uses the light path O₁-O₂-O₃, and its SRLG list is consequently {S₁,S₂}. The link R₂R₃ uses the light path O₂-O₃ and its SRLG list is therefore summarised as {S₂}. It is therefore found that the links R₁R₂ and R₂R₃ have an SRLG diversity but that these do not have one with the link R₁R₃.

An SRLG failure is defined as the failure of the physical resource shared by the various elements of the SRLG. Thus, in the previous example, a failure of the SRLG S₂ corresponds to a failure of the fibre f₂.

An SRLG failure may cause the failure of several links. Thus, in the previous example, the failure of SRLG S₂ will give rise to a failure of the links R₁R₃ and R₂R₃. In general terms, the failure of a given SRLG will give rise to the failure of the links whose SRLG lists contain it.

Conversely, the failure of a link may not be related to the failure of an SRLG. Thus, in the previous example, the failure of the link R₂O₂ connecting R₂ to R₃ gives rise to a failure of the link R₂R₃ but not of the SRLG S₂. In general terms, if a link does not belong to any SRLG, the failure of this link will not be linked to the failure of an SRLG.

The local protection method according to the invention comprises two phases, a first phase known as the General Admission Control or GAC phase and a second phase known as Local Admission Control or LAC for a bypass tunnel. During the first phase, a PLR point on an LSP path determines, from an ingress router request, whether local protection is to be implemented and, where applicable, the type of protection requested (link, node) as well as the value of the bandwidth required for protecting the LSP path. The PLR point next determines the bypass tunnel path whilst simulating its admission by the network. In the second phase, the PLR proceeds with the effective creation of the bypass tunnel in a manner similar to that of a conventional LSP path by transmitting a message similar to a message “Path” along the bypass tunnel path and receiving the corresponding acknowledgement message “Resv”.

A first embodiment of the invention will be disclosed first of all.

General Admission Control comprises two steps. In the first step, the PLR determines whether there exists one or more existing bypass tunnels for providing the protection requested. In this way candidate bypass tunnels are obtained. The candidate bypass tunnels cannot use the element to be protected.

In the case of a link to be protected, the PLR determines, from its local database, for each link of the candidate bypass tunnel (NHOP), whether it has an SRLG diversity with this link: in the negative the candidate bypass tunnel is not compatible in terms of risk and cannot be adopted;

in the case of a node to be protected, the PLR determines, from its local database, for each link of the candidate bypass tunnel (NNHOP), whether it has an SRLG diversity with the link joining the PLR and the node to be protected; in the negative the bypass tunnel is not compatible in terms of risk and cannot be adopted.

If there exists at least one candidate bypass tunnel T satisfying the compatibility criterion, the PLR node simulates an increase in the bandwidth b(T) of the tunnel by the value b(LSP) of the bandwidth required for protecting the LSP path. The PLR node then checks whether, for each link L of the bypass tunnel, the new value b(T) is such that b(T)≦RBP((L). If such is the case the bypass tunnel is adopted definitively. Failing this, the other candidate tunnels satisfying the compatibility criterion are tested one after the other.

If none of the candidate bypass tunnels can be adopted for reasons of incompatibility of risk or insufficient bandwidth, the PLR point simulates, in a second step, the creation of a new bypass tunnel.

The construction of a new bypass tunnel is simulated in the following manner: from the PLR point as far as a PM point (Point of Merging) of the LSP path downstream of the element to be protected, the PLR selects amongst the network links those which can support the bypass tunnel. The admission criteria used for a link L are the same as those indicated above, namely:

the link L must be distinct from the link to be protected;

if the element to be protected is a link, the link L must have an SRLG diversity with the link to be protected;

if the element to be protected is a node, the link L must have an SRLG diversity with the link joining the PLR and the node to be protected.

In addition, if protection of the bandwidth is required, the PLR point simulates for each link L an increase in the bandwidth reserved for the protection on this link, that is to say: rBP(L)=rBP(L)+b(LSP) and tests whether the condition rBP(L)≦RBP(L) is satisfied. In the negative, the link cannot accept the bypass tunnel and is rejected. In the affirmative, on the other hand, the bypass tunnel can a priori take the link and is selected.

The result of the previous selection is a sub-network of the initial network where the non-selected links have been cut out. The PLR point then determines the shortest path in the sub-network (CSPF), for example by means of Dijkstra's algorithm. This path will be the one which the bypass tunnel will take.

If no bypass tunnel can be constructed, the PLR point advises the ingress router of this via the LSP path.

It should be noted that some nodes in the network may be excluded by the operator as not being able to provide local protection. In other words, such a node will not be able to be PLR for any LSP path passing through it. In this case, when such a node receives a local protection request, it advises the ingress router, via the LSP path, that the protection cannot be achieved.

It has been assumed in the above that it is necessary to protect the bandwidth of the LSP path (b(LSP)). However, it may turn out that protection of the bandwidth is not necessary (the protection of the LSP path is then of the “Best Effort” type). In this case, a specific bypass tunnel, dedicated to the “Best Effort” protection, will be used by the PLR.

When a bypass tunnel has been determined by the PLR point, a signalling phase is passed to with local admission control which actually creates the bypass tunnel. The PLR point then transmits the message of the “Path” type indicating in particular the bypass tunnel path and the bandwidth required for the protection, b(LSP). Each link once again proceeds with checking its SRLG diversity with the element to be protected. If this SRLG diversity is verified, a test is carried out once again to determine whether the condition rBP(L)≦RBP(L) is satisfied and, in the affirmative, the actual modification of the bandwidth reserved for the protection on this link, that is to say rBP(L)=RBP(L)+b(LSP), is proceeded with. These new verification steps are explained by the fact that the diversity situation or the resources of the link have been able to change between the general and local admission control phases, in particular if other bypass tunnels have been created in the interval. If all the verifications are positive, it is certain that there is effective protection of the bandwidth of the LSP path. On the other hand, if one of the verification steps fails, an error message is transmitted along the bypass tunnel to the PLR point, which will then be able to advise the ingress router.

As with a conventional LSP path, the MPLS tables of the bypass tunnels are established during the retropropagation of the acknowledgement message “Resv”.

It should be noted that the actual reservation of the bandwidth can be made during the routing of the message “Path” or during the retropropagation of the acknowledgement message.

A second embodiment of the invention will now be disclosed.

According to this second embodiment, the construction of the bypass tunnel is carried out by sharing already existing tunnel resources. This embodiment finds its justification in the fact that two physical elements of the network have only a very small probability of being faulty at the same time. The failure of a physical element gives rise to the failure of a certain number of IP links and/or nodes in the network which use it. Thus, in the case of failure of a physical element, only certain paths will be affected. The protection resources for protecting the paths which are not affected at the same time by the failure of the same physical element are able to be shared and consequently saved on.

For this purpose, a Failure Risk or FR is defined as a link, a node or an SRLG. Naturally, for an SRLG, the actual risk of failure concerns the underlying physical resource but, for reasons of simplification, the SRLG will be associated with the physical resource in question.

In addition, the failure risk group or TFRG (standing for Tunnel Failure Risk Group) of a bypass tunnel is defined as being all the failure risks protected by this tunnel. Thus the TFRG of an NHOP bypass tunnel is the assembly formed by the link downstream and the SRLG list of this link. Likewise the TFRG of an NNHOP bypass tunnel is the assembly formed by the node which it protects, the link connecting the PLR point to this node and the SRLG list of this link.

Likewise, the failure risk group or LFRG (standing for Link Failure Risk Group) of a link is defined as all the failure risks protected by the bypass tunnels passing through this link.

Finally, the bandwidth protecting a risk of failure Φ is defined by a link L of a bypass tunnel protecting Φ (in other words whose TFRG contains Φ), and is denoted BP(Φ,L), the bandwidth reserved or to be reserved on this link for protecting Φ. Naturally this bandwidth will have to be less than the protection band of the link L, that is to say BP(Φ,L)≦RBP(L).

The protection method according to the second embodiment also comprises a general admission phase and a local admission phase.

The general admission phase of the second mode differs from that of the first mode when protection of the bandwidth is required.

During the first step where the PLR seeks to use an existing bypass tunnel, instead of simulating the increase in the bandwidth rBP(L), for each link L of the candidate tunnel the new bandwidth which it will be necessary to reserve for protecting the element in question of the path LSP is calculated, that is to say rBP(L)=max(BP(Φ,L)) where ΦεLFRG(L), it being understood that, for this calculation, it has been assumed that the candidate bypass tunnel passed through the link L.

A test is then carried out to determine whether the condition rBP(L)≦RP(L) is satisfied in order to determine whether the link L can still support the candidate bypass tunnel. If this condition is satisfied for all the links of the candidate bypass tunnel, the latter is adopted. The candidate tunnels satisfying the compatibility criterion are tested one after the other. A tunnel is then chosen from amongst those adopted for example according to a criterion of degree of occupation of the protection bandwidth.

Likewise, for the second step, that is to say when it is necessary to simulate the construction of a bypass tunnel, the criteria for selection of a link L must be modified in the following manner: instead of simulating the increase in the bandwidth on the candidate link, protection of the element in question is simulated and the new bandwidth which it will be necessary to reserve for accepting the bypass tunnel is calculated for the link L, that is to say rBP(L)=max(BP(Φ,L)) where ΦεLFRG(L), it being understood that, for this calculation, the bypass tunnel is assumed to pass through the link L. As before, it is then tested whether the condition rBP(L)≦RBP(L) is satisfied. In the affirmative, the candidate link is selected for the determination of the CSPF.

The local admission phase of the second mode differs from that of the first mode when protection of the bandwidth is required. For a given link L of the bypass tunnel, the actual modification of the bandwidth reserved for the protection on this link, that is to say rBP(L)=max(BP(Φ,L)) is proceeded with, after having verified the diversity of the link with the element to be protected, and it is tested once again whether the condition of rBP(L)≦RBP(L) is satisfied. As in the first embodiment, if all the verifications are positive, it is certain that there is effective protection of the bandwidth of the LSP path. On the other hand, if one of the verification steps fails, an error message is transmitted along the bypass tunnel to the PLR point.

FIG. 8 illustrates schematically the local protection method according to an example embodiment of the present invention. The local protection request is requested at 800 by the ingress router (LSR Ingress) of the LSP path by means of protection parameters included in the object Session_Attribute Object (SAO) of the RSVP-TE protocol. The protection request is indicated by a flag in the object SAO.

In addition, a Local Protection Bit LPD in the object SAO indicates to each PLR whether a bypass tunnel is to be sought/constructed.

A Node Protection Bit NPD in the object SAO indicates to each PLR the type of protection requested (NNHOP or NHOP).

Finally, a Bandwidth Protection Bit BPD in the object SAO indicates to each PLR whether or not the bypass tunnel should offer bandwidth protection.

The PLR point determines from the LPD bit whether a bypass tunnel is requested and, in the affirmative, initiates at 810 the GAC phase. At 811, the PLR point determines the candidate bypass tunnels, that is to say the existing tunnels able to provide the protection requested. At 812 it checks the diversity condition for each link of each candidate bypass tunnel. If for any link it is not verified, the candidate is not adopted. At 813, it is tested whether at least one candidate is adopted. In the negative the construction step 817 is passed to directly. For each candidate adopted, the protection of the LSP path by the candidate bypass tunnel is simulated at 814 and the new value of the bandwidth to be reserved is calculated (according to the first embodiment or the second embodiment) for each bypass link. It is tested at 815 whether the protection bandwidth on the link is sufficient to allow this value. The test is performed for each link of the bypass. It is checked at 816 whether the test is positive for all the links of the candidate bypass. If such is the ease, the PLR transmits a message “Path” and the local admission phase is passed to. In the contrary case the following candidate is passed to until they have all been tested. According to a variant, if several candidates adopted satisfy the bandwidth condition one of them will be chosen according to a predetermined criterion, for example a criterion of occupation of the protection bandwidth.

If all the candidates have been tested and none finally adopted, the creation of a new bypass tunnel is simulated at 817, considering only the links in the network which satisfy the diversity and bandwidth conditions, as explained above. The CSPF path is then calculated at 818. The PLR tests at 819 whether a bypass tunnel has been able to be constructed. In the negative, the ingress router is advised of this. In the affirmative, the PLR transmits a message “Path” and the local admission phase is passed to.

Each link in the bypass tunnel initiates at 820 a local admission check and checks at 821 whether the diversity condition is still satisfied. In the negative, an error message is transmitted to the PLR. If it is indeed satisfied, it is tested at 822 whether the protection bandwidth sufficiency condition is satisfied and in the affirmative the value of the reserved bandwidth rBP(L) is updated at 823. In the negative, an error message is transmitted to the PLR. The local admission check ends at 824.

The implementation of the protection method according to the invention assumes that each node in the network able to be PLR has access to a certain number of items of information such as the protection bandwidth RBP(L) on each link L, the reserved bandwidth rBP(L), the existing bypass tunnels and their characteristics. This information is the subject of announcements in the network and serves to update the local databases TED. Conversely, when a PLR point adopts an existing bypass tunnel for protecting a new element in the network or when it creates a new bypass tunnel (using or not existing tunnel resources) this bypass tunnel must be signalled to the network.

Advantageously, the announcements are made by means of an extension of the OSPF-TE protocol or an extension of the ISIS-TE protocol. A description of the OSPF-TE protocol will be found in particular in the document by D. Katz et al. entitled “Traffic Engineering Extensions to OSPF” and of the protocol ISIS-TE in the document by H. Smit et al. entitled “IS-IS extensions for Traffic Engineering”. These two documents are available on the aforementioned IETF site. It should be stated that the OSPF-TE and ISIS-TE protocols make it possible to broadcast on the network information necessary for traffic engineering such as the immediate links of each node and the constraints (for example the maximum reservable bandwidth, the metrics etc) associated with each link. This information is transmitted in the form of messages comprising a header and a certain number of data, each being in a so-called TLV (standing for Type, Length, Value) format indicating the type, the length and the value of the data item. A data item in this format, also by assimilation called TLV, can comprise other data according to a TLV format, called for this reason sub-TLV.

The OSPF-TE and ISIS-TE protocols can be extended by adding new TLVs or new sub-TLVs in the existing TLVs.

Thus the TLV giving the characteristics of a link (TLV Link in the OSPF-TE protocol and IS reachability in the ISIS-TE protocol) is extended by means of the following sub-TLVs:
sub-TLV indicating the reservable protection bandwidth (RBP(L)) on this link
sub-TLV indicating the bandwidth on this link actually reserved for the protection rBP(L)
sub-TLV indicating the SRLG list of this link.

A new TLV, referred to as the bypass TLV, is also introduced, giving the characteristics of a bypass tunnel and comprising three sub-TLVs:
sub-TLV “Tail Router Id” giving the IP address serving to identify the PM (Point of Merging) node where the bypass tunnel rejoins the protected LSP path
sub-TLV “Path” giving the path taken by the bypass tunnel
sub-TLV “Information” giving the type of bypass tunnel (NHOP, NNHOP), the IP address of the protected node (if type=NNHOP), the local IP address (IP address of the PLR point) and distant IP address (IP address of the node downstream of the PLR point) of the link protected (if type=NHOP) and the bandwidth of the bypass tunnel.

In addition, the local admission phase of the bypass tunnel assumes that the RSVP-TE protocol is extended by modifying in particular the message “Path”. A new object is introduced into this message in order to define the bypass tunnel. It contains the following fields:
type of bypass (NHOP or NNHOP)
IP address of protected node, if type=NNHOP
IP address of PLR point upstream of the protected link (local IP address), if type=NHOP
IP address of downstream node (PLR next hop) of protected link (distant IP address), if type-NHOP
SRLG list of protected link if it is a case of a link and the link joining the said PLR point and the node downstream of the said PLR point, if it is a case of a node.

Naturally a person skilled in the art can extend the CR-LDP protocol in an equivalent fashion.

1-7. (canceled)

8. A method of protecting a label switching path in an MPLS network having a plurality of nodes connected by IP links, the path commencing with an ingress node and ending in an egress node of the network, the path passing through a given series of nodes and links in the network, the nodes and links being referred to as elements of the path, the method being performed when the ingress node requires the protection of an element of the path, the method comprising a first phase, known as a general check phase, during which a node of the path, referred to as an PLR point, upstream of the path element to be protected, determines that at least one bypass tunnel among the existing bypass tunnels to be created is to join the path upstream of the element to be protected as a node, referred to as a PM point and fulfilling general admission criteria, and a second phase during which the bypass tunnel to be created is created with a local admission check, the first phase comprising a second step which is performed if none of the existing bypass tunnels fulfils the general admission criteria, during the second step simulating the creation of a new bypass tunnel by using only the links in the network which can support the new bypass tunnel, then forming said bypass tunnel to be created by using said new bypass tunnel.

9. The method of claim 8, wherein the second step of the first phase is performed by using a link able to support the new bypass tunnel in response to the new bypass tunnel fulfilling the following admission criteria:
the link is distinct from the link to be protected;
if the element to be protected is a link, the link has an SRLG diversity with the link to be protected; and
if the element to be protected is a node, the link has an SRLG diversity with the link joining the PLR point and the node to be protected.

10. The method of claim 9, wherein the second step of the first phase includes (a) simulating protection of the element to be protected, (b) calculating the bandwidth to be reserved on each link of the bypass tunnel, and (c) verifying that the bandwidth is less than the value of the protection bandwidth (RBP(L)) of the link.

11. The method of claim 10, wherein the second step of the first phase includes simulating an increase in the bandwidth reserved for the protection on each link of the new bypass tunnel by the value of the bandwidth required for protecting the tunnel, then verifying that the value of the resulting bandwidth on this link is less than the value of the protection bandwidth (RBP(L)) on the link.

12. The method of claim 10, wherein the bandwidth of each link of the new tunnel which is reserved for protecting the element is equal to the bandwidth of a risk of failure of the element to be protected.

13. The method of claim 12, wherein the adopted bypass tunnel to be created is the one tunnel among all the possible bypass tunnels which has the shortest path in the network.

14. The method of claim 13, wherein the second phase includes:
transmitting a first message so the first message propagates from node to node on the bypass tunnel to be created towards the point PM;
returning a second message along the bypass tunnel towards the point PLR;
responding to passage of the first or second message by determining, for each link in the bypass tunnel, that it is able to protect the element and that the resources are actually available on this link; and
reserving in affirmative the resources in response to the determining step being in the affirmative.

15. The method of claim 8, wherein the second step of the first phase includes (a) simulating protection of the element to be protected, (b) calculating the bandwidth to be reserved on each link of the bypass tunnel, and (c) verifying that the bandwidth is less than the value of the protection bandwidth (RBP(L)) of the link.

16. The method of claim 10, wherein the adopted bypass tunnel to be created is the one tunnel among all the possible bypass tunnels which has the shortest path in the network.

17. The method of claim 8, wherein the second phase includes:
transmitting a first message so the first message propagates from node to node on the bypass tunnel to be created towards the point PM;
returning a second message along the bypass tunnel towards the point PLR;
responding to passage of the first or second message by determining, for each link in the bypass tunnel, that it is able to protect the element and that the resources are actually available on this link; and
reserving in affirmative the resources in response to the determining step being in the affirmative.
